(19) United States
(12) Patent Application Publication
(10) Pub. No.: US 2017/0162839 A1
(43) Pub. Date: Jun. 8, 2017

(54) Super Cells Formed of Cylindrical Electrochemical Cells

(71) Applicants: Bosch Battery Systems, LLC, Orion, MI (US); Robert Bosch GmbH, Stuttgart (DE)

(72) Inventors: Mehul Botadra, Sterling Heights, MI (US); Mark Kotik, Rochester Hills, MI (US)

(21) Appl. No.: 14/962,478

(22) Filed: Dec. 8, 2015

(51) Int. Cl. H01M 2/10; H01M 10/0525

(52) U.S. Cl. CPC H01M 2/105; H01M 2/1077; H01M 10/0525; H01M 2220/20; H01M 2220/30

(57) ABSTRACT

A super cell housing is configured to support cylindrical electrochemical cells in a highly volumetrically efficient arrangement. The super cell housing includes a first tray and a second tray that cooperate to secure the cells therebetween. The first and second trays are identical, and include a base having a cell-facing surface and an opposed outward-facing surface, and a sidewall that surrounds a periphery of the base. A sidewall inner surface has concave contours that each define a portion of a cylindrical surface. The base includes protrusions that extend in a direction normal to the cell-facing surface and are surrounded by the sidewall. Outer surfaces of the protrusions having concave contours that each define a portion of a cylindrical surface. The concave contours of the sidewall and the protrusion cooperate to form cell-receiving openings. At least one of the protrusions includes a through hole that opens at the outward-facing surface.

### BACKGROUND

1. Field of the Invention

The present invention relates to efficient packing of cylindrical electrochemical cells in a polygonal structure to form super cells used for power generation and storage.

2. Description of the Related Art

Battery packs provide power for various technologies ranging from portable electronics to renewable power systems and environmentally friendly vehicles. For example, hybrid electric vehicles use a battery pack and an electric motor in conjunction with a combustion engine to increase fuel efficiency. Battery packs are formed of a plurality of battery modules, where each battery module includes several electrochemical cells. The cells are arranged in stacks and are electrically connected in series or in parallel. Likewise, the battery modules are electrically connected in series or in parallel.

Different cell types have emerged in order to deal with the space requirements of a very wide variety of installation situations, and the most common types used in vehicles are cylindrical cells, prismatic cells, and pouch cells. Regardless of cell type, each cell includes an electrode assembly that is sealed within a cell housing along with an electrolyte to form a power generation and storage unit. The electrode assembly may include an alternating arrangement of positive and negative electrode elements separated by intermediate separator plates, and can be provided in various configurations. The electrode assembly of a cylindrical cell is typically formed by winding an elongated electrode pair into a jelly-roll configuration.

Due to their curved shape, cylindrical cells do not pack well in a battery pack and support structures are required in the battery pack to provide a stable, ordered arrangement of cylindrical cells therein. In addition, since the typical battery pack has a polygonal (rectangular or other) shape, cylindrical cells provide low volumetric efficiency within a polygonal battery pack when compared to, for example, prismatic cells.

### SUMMARY

In some aspects, a super cell housing is configured to receive cylindrical electrochemical cells. The super cell housing includes a first tray, the first tray having a base having a cell-facing surface and an opposed outward-facing surface, a sidewall surrounding a periphery of the base, a sidewall inner surface having concave contours that each define a portion of a cylindrical surface, and protrusions. The protrusions extend in a direction normal to the cell-facing surface and are surrounded by the sidewall, and outer surfaces of the protrusions have concave contours that each define a portion of a cylindrical surface. At least one of the protrusions includes a through hole that opens at the outward-facing surface.

The super cell housing may include one or more of the following features: The at least one of the protrusions has an inner surface that defines the through hole, and the inner surface has the same cross-sectional shape as the outer surface of the at least one of the protrusions. The at least one of the protrusions includes a dividing wall that extends between two portions of the inner surface and separates the through hole into multiple through holes. The at least one of the protrusions includes a sleeve disposed in the through hole that conforms to a shape of the protrusion inner surface, and the sleeve is formed of a material that is different from the material that forms the protrusion. The sleeve includes a dividing wall that extends between two portions of an inner surface of the sleeve and separates the sleeve into multiple through holes. The first tray includes multiple protrusions, and at least some of the protrusions have an outer surface that is defined by four concave contours, and others of the protrusions have an outer surface that is defined by three concave contours, where the at least some of the protrusions include the through hole and the others of the protrusions are through hole free. The protrusions are formed integrally with the base and protrude from the cell-facing surface at a location spaced apart from the sidewall. The protrusions are formed separately from the base, and are received within a recess formed in the cell-facing surface at a location spaced apart from the sidewall. A concave contour of the outer surface of each protrusion faces, and has a same radius as, a concave contour of the sidewall. A first concave contour of an outer surface of one of the protrusions faces, and has a same radius as, a second concave contour of the sidewall or of another one of the protrusions, and the distance between the first concave contour and the second concave contour is twice the radius, whereby the first concave contour and the second concave contour are configured to cooperatively support an electrochemical cell having the radius therebetween.

The super cell housing may also, or alternatively, include one or more of the following features: A first concave contour of an outer surface of a one of the protrusions faces a second concave contour of the sidewall or of another one of the protrusions, and the first concave contour and the second concave contour have a first radius. A third concave contour of an outer surface of one of the protrusions faces a fourth concave contour of the sidewall or of another one of the protrusions, and the third concave contour and the fourth concave contour have a second radius that is different than the first radius. The distance between the first concave contour and the second concave contour is twice the first radius, whereby the first concave contour and the second concave contour are configured to cooperatively support an electrochemical cell having the first radius therebetween. In addition, the distance between the third concave contour and the fourth concave contour is twice the second radius, whereby the third concave contour and the fourth concave contour are configured to cooperatively support another electrochemical cell having the second radius therebetween. The super cell housing includes a second tray that is spaced apart from the first tray, the second tray including protrusions that protrude toward the protrusions of the first tray. The outward-facing surface includes recesses that are configured to receive an end of a connecting rib. The super cell housing includes a connecting rib that protrudes outward from the outward-facing surface. A terminal plate is provided on the outward-facing surface of the first tray, the terminal plate configured to form an electrical connection with each cell disposed in the tray.

In some aspects, a battery pack includes a first super cell and a second super cell that is connected to the first supercell via a connector. Each of the first super cell and the second super cell include a super cell housing, and the super cell housing includes a first tray. The first tray includes a base having a cell-facing surface and an opposed outward-facing surface, a sidewall surrounding a periphery of the base, and a sidewall inner surface having concave contours that each define a portion of a cylindrical surface. The first tray includes protrusions that extend in a direction normal to the cell-facing surface and are surrounded by the sidewall. Outer surfaces of the protrusions have concave contours that each define a portion of a cylindrical surface, and at least one of the protrusions includes a through hole that opens at the outward-facing surface.

The battery pack may include one or more of the following features: The connector is a rod that is formed separately from each of the first supercell and the second supercell. The rod has a first end and a second end that is opposed to the first end. The first end is disposed within a recess formed in the first supercell, and the second end is disposed within a recess formed in the second supercell. The connector has a first end that is received within a first opening formed in the outward-facing surface of the first tray, and a second end opposed to the first end. The second end is received within a second opening formed in an outward-facing surface of the second tray. The connector is polygonal in cross sectional shape. The connector is a rod having a triangular cross sectional shape. The base is formed of a first material and the connector is formed of a second material, and the first material is different from the second material. The at least one of the protrusions has an inner surface that defines the through hole, and the inner surface has the same cross-sectional shape as the outer surface of the at least one of the protrusions. The at least one of the protrusions includes a dividing wall that extends between two portions of the inner surface and separates the through hole into multiple through holes. The at least one of the protrusions includes a sleeve disposed in the through hole that conforms to a shape of the protrusion inner surface, the sleeve being formed of a material that is different from the material that forms the protrusion. The sleeve includes a dividing wall that extends between two portions of an inner surface of the sleeve and separates the sleeve into multiple through holes. A terminal plate is provided on the outward-facing surface of the first tray, the terminal plate forming an electrical connection with each cell disposed in the tray.

The super cell disclosed herein includes a one piece or two piece jacket having cylindrical openings that receive cylindrical cells. The cylindrical openings are arranged to maximize cell packing within the volume of the jacket and such that the cells are tangential to adjacent cells. The super cell also includes a support structure disposed in the interstice between adjacent cells. The support structure outer surface includes concave contours that conform to the shape of the cells that surround it. The support structure supports the entire structure and holds the cells in the desired position. In some embodiments, at least one of the support structures is hollow. In some embodiments, the hollow space within the support structure is divided to provide a multi-lumen passageway between opposed ends of the jacket. Advantageously, the lumens can be used for multiple purposes. For example, the lumens of a given support structure can be used as passage for cooling air, or used to receive communication buses, sensor leads or other devices, further improving the volumetric efficiency of the super cell.

In some embodiments, the hollow interior space of the support structure is lined with a hollow sleeve that is formed of a material that is different than the material used to form the jacket. For example, in some embodiments the jacket is formed of a relatively less expensive material that has relatively low thermal conductivity (i.e., a polymer such as polyethylene), and the sleeve is formed of a relatively more expensive material that has a relatively high thermal conductivity (i.e., aluminium). This configuration provides better thermal management of jacket and cell temperatures than a super cell that is formed having both the jacket and sleeve formed of the polymer.

In some embodiments, the super cell includes connecting ribs that are used to connect one super cell to an adjacent super cell. The ribs are formed separately from the respective jackets, and are disposed in a recess in an end of each of the jackets. The recess is shaped and dimensioned to receive the rib in a press fit configuration. The length of each rib is equal to or less than the sum of the depths of the recesses that receive it, whereby the facing surfaces of the jackets are in contact with each other. This is advantageous since it permits close packing of the super cells within a battery pack housing, as well as a direct electrical connection (e.g., lead wire-free or bus-free) to be formed between adjacent super cells.

Moreover, the super cell includes an electrical conductor disposed on each end of the jacket. The electrical conductor is electrically connected to each cell disposed within the jacket, whereby the cells disposed within a given jacket are electrically connected in parallel. When the super cell is connected to an adjacent super cell via one or more ribs, the electrical conductors of the adjacent jackets contact each other and a direct serial electrical connection is formed between the adjacent super cells. This is advantageous relative to some conventional methods of electrically connecting different modules within a battery pack since there is no need for buss bars or other devices to form the electrical connection between the super cells.

The super cell provides a functional system that includes cylindrical cells of various capacities arranged in a physically compact form and electrically connected in parallel. The super cell has a volumetric efficiency of about 65 percent, and when arranged to form a rectangular pack, can provide a pack volumetric efficiency of about 60 percent. This can be compared to some conventional prior art battery packs including cylindrical cells having a volumetric efficiency of 25 percent or less.

### BRIEF DESCRIPTION OF THE DRAWINGS

FIG. 1 is a perspective view of a battery pack with the lid omitted for clarity, illustrating an array of super cells disposed within the battery pack.

FIG. 2 is a perspective view of a super cell including four cylindrical electrochemical cells disposed in a jacket and supported by a central support member.

FIG. 3 is a perspective view of the jacket of FIG. 2.

FIG. 4 is a perspective view of the support member FIG. 2.

FIG. 5 is a perspective view of the super cell of FIG. 2 including an alternative embodiment support member.

FIG. 6 is a perspective view of an alternative embodiment super cell illustrating a jacket having a hexagonal cross-sectional shape.

FIG. 7 is a perspective view of another alternative embodiment super cell that includes multiple sized cells.

FIG. 8 is a perspective view of an alternative embodiment super cell illustrating a two-piece jacket.

FIG. 9 is an exploded view of the super cell of FIG. 8.

FIG. 10 is a top plan view of the terminal plate of the super cell of FIG. 8.

FIG. 11 is a top plan view of an alternative embodiment terminal plate.

FIG. 12 is a perspective view of the cell-facing surface of the first tray of the jacket.

FIG. 13 is a cross sectional view of the first tray as seen along line 13-13 of FIG. 9.

FIG. 14 is a cross-sectional view of an alternative embodiment first tray.

FIG. 15 is a cross-sectional view of another alternative embodiment first tray.

FIG. 16 is a cross-sectional view of another alternative embodiment first tray.

FIG. 17 is a perspective view of the outward facing surface of the first tray of the jacket illustrating recesses formed in the outward facing surface for receiving the connecting ribs.

FIG. 18 is a perspective view of the outward facing surface of the first tray of the jacket illustrating the connecting ribs disposed in the recesses.

FIG. 19 is a top plan view of a battery pack with the lid omitted for clarity, illustrating an array of super cells disposed within the battery pack.

### DETAILED DESCRIPTION

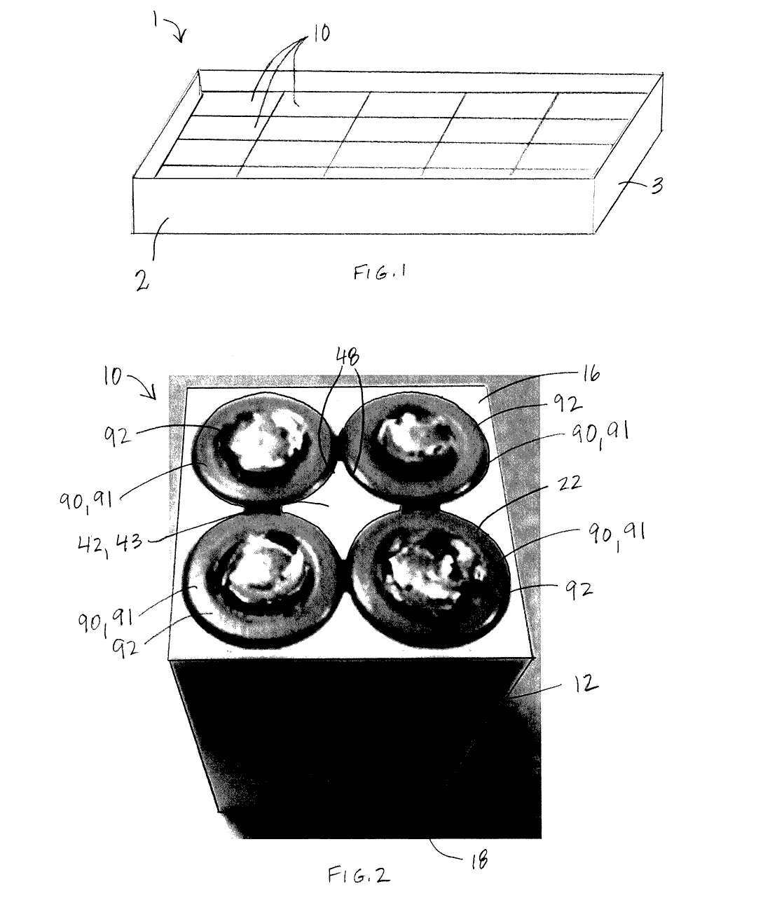

Referring to FIGS. 1-2, a battery pack 1 used to provide electrical power includes an array of electrochemical cells 90 that are electrically interconnected and stored within a battery pack housing 2. The battery pack housing 2 includes a container portion 3 and a detachable lid (not shown). The cells 90 are lithium-ion secondary cylindrical cells that include an electrode assembly (not shown) that is sealed within a cell housing 91 along with an electrolyte to form a power generation and storage unit. In some embodiments, groups of cells 90 may be arranged within a jacket 12 and supported therein by interstitial support members 42 to form super cells 10, as discussed further below. The super cells 10, in turn, are stored within the battery pack housing 2. Within the battery pack housing 2, the super cells 10 are electrically connected in series.

Each cell 90 includes the cylindrical cell housing 91 which includes a first end 92 having a positive terminal 95, and a second end (not shown) that is opposed to the first end 92. The second end includes a negative terminal.

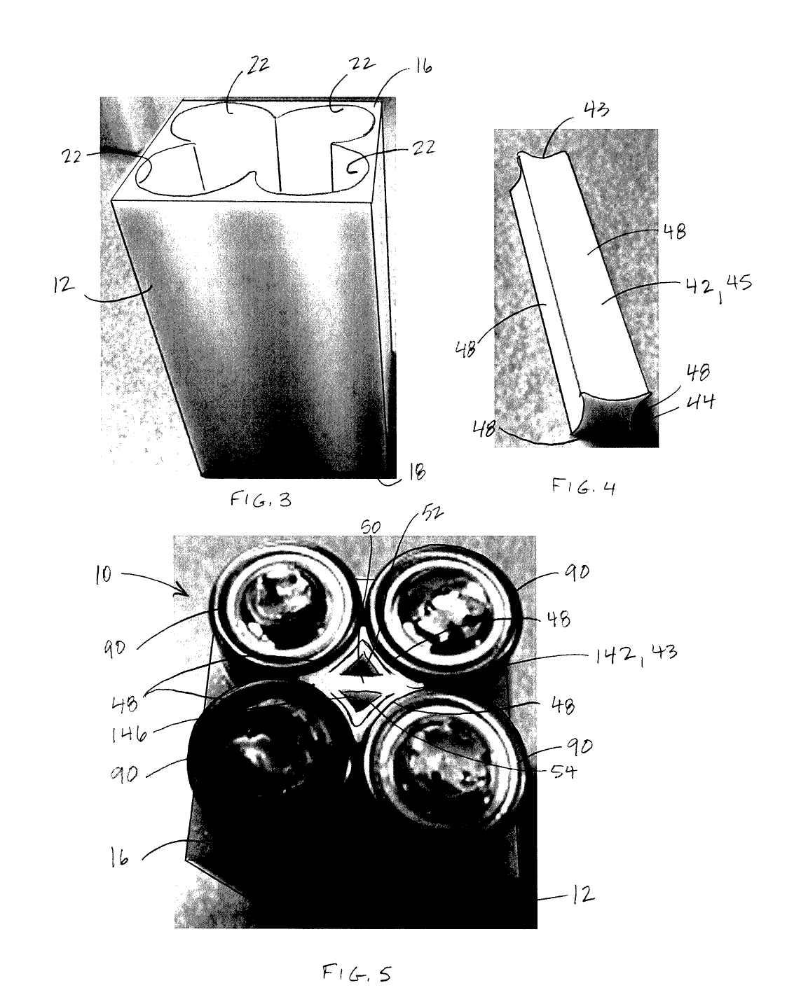

Referring to FIG. 3, the jacket 12 is a one piece member having a rectangular shape, including four sides that extend between opposed ends 16, 18. The jacket 12 is formed for example by extrusion to have cylindrical openings 22. Each opening 22 is shaped and dimensioned to receive one of the cells 90. The openings 22 extend between the first end 16 and the second end 18, and have a first diameter adjacent the first end 16 and a second diameter adjacent the second end 18. The first diameter corresponds to the outer diameter of the cell 90 with a clearance fit, and the second diameter is smaller than the outer diameter of the cell 90 while being sufficiently large to permit access to the cell terminal positioned adjacent the jacket second end 18. The stepwise transition between the first and second diameters occurs adjacent the jacket second end, forming a shoulder (not shown) that supports the cell end (i.e., the cell second end) and prevents the cells 90 from exiting the jacket 12 via the jacket second end 18. The depth of the shoulder is set such that the end of the cell 90 (i.e., the first end 92) lies flush with the jacket first end 16. The openings 22 each have the same diameter, and the openings 22 are arranged to maximize cell packing within the volume of the jacket 12 and such that each cell 90 is tangential to two adjacent cells 90.

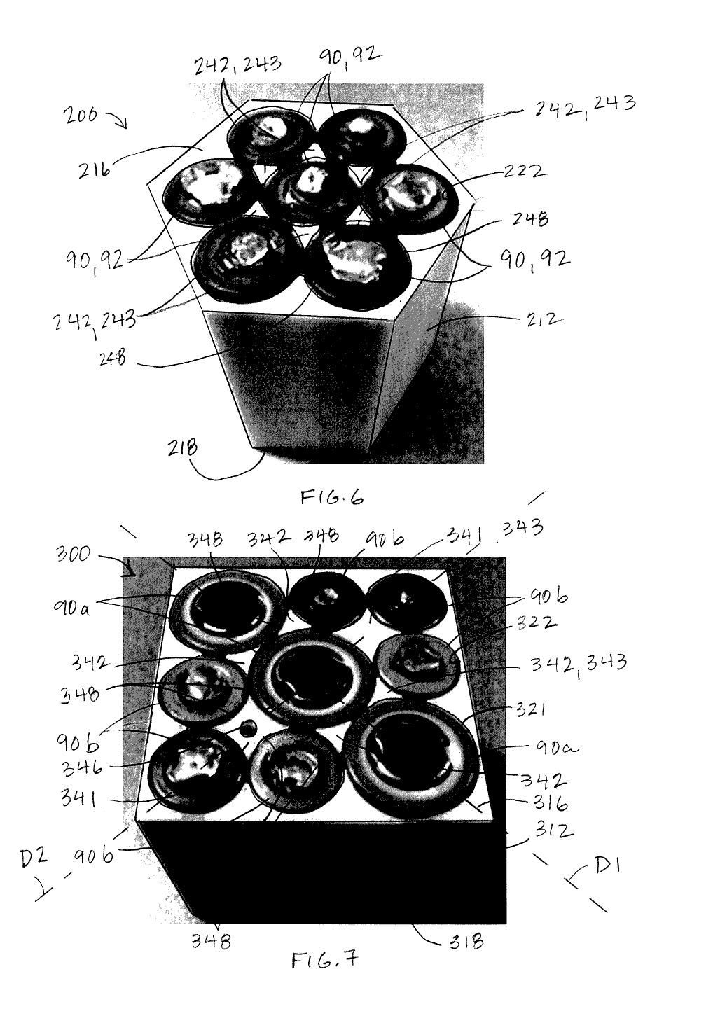

Referring to FIGS. 2 and 4, the interstitial support member 42 is formed separately from the jacket 12, and is an elongated, solid rod-like member having a first end 43, and a second end 44 opposed to the first end 43. In use, the support member 42 is configured to be disposed in the interstice between adjacent cells 90 in a close-fit relationship therewith. To this end, the outer surface 45 of the support member 42 includes concave contours 48 that conform to the shape of the cells 90 that surround it. In the illustrated embodiment, the support member 42 is disposed in an interstitial space between four adjacent cells 90, and thus has four concave contours. The support member 42 supports the entire structure and holds the cells 90 in the desired position.

Referring to FIG. 5, the super cell 10 may include an alternative interstitial support member 142 that is similar to the support member of FIGS. 2 and 4, and thus common reference numbers will be used to refer to common elements. The support member 142 is an elongated, hollow rod-like member having concave contours 48 that conform to the shape of the cells 90 that surround it. The support member 142 includes a central channel 146 that extends between the opposed first and second ends 43, 44. The channel 146 has a cross sectional shape that corresponds to the cross sectional shape of the outer surface 45 of the support member 142. In the illustrated embodiment, the channel 146 includes a dividing wall 50 that separates the channel 146 into two lumens 52, 54. In other embodiments, the channel 346 (FIG. 7) is formed without the dividing wall 50 such that a single lumen extends between the opposed ends 43, 44 of the support member 142. The lumens 52, 54 can be used, for example, as passage for cooling air, or used to receive communication buses, sensor leads or other devices.

Referring to FIG. 6, an alternative embodiment super cell 200 includes cells 90 disposed in a single piece jacket 212 and supported by interstitial support members 242. The jacket 212 has a hexagonal shape, including six sides that extend between opposed ends 216, 218. The jacket 212 is formed for example by extrusion to have cylindrical openings 222. The openings 222 open at a first end 216 of the jacket 212 and extend toward the opposed second end 218 of the jacket 212. Each opening 222 is shaped and dimensioned to receive one of the cells 90. In particular, the openings 222 extend between the first end 216 and the second end 218, and have a first diameter adjacent the first end 216 and a second diameter adjacent the second end 218. The first diameter corresponds to the outer diameter of the cell 90 with a clearance fit, and the second diameter is smaller than the outer diameter of the cell 90 while being sufficiently large to permit access to the cell terminal positioned adjacent the jacket second end 218. The stepwise transition between the first and second diameters occurs adjacent the jacket second end 218, forming a shoulder (not shown) that supports the cell end (i.e., the cell second end 93) and prevents the cells 90 from exiting the jacket 212 via the jacket second end 218. The depth of the shoulder is set such that the end of the cell 90 (i.e., the first end 92) lies flush with the jacket first end 216. The openings 222 each have the same diameter, and the openings 222 are arranged to maximize cell packing within the volume of the jacket 212 and such that each cell 90 is tangential to two adjacent cells 90.

In this embodiment, there are six support members 242 that are disposed in the interstitial spaces between seven closely packed cells 90. The interstitial support members 242 are formed separately from the jacket 212, and each is an elongated, rod-like member having a first end 243, and a second end (not shown) opposed to the first end 243. In use, the support members 242 are configured to be disposed in the interstices between adjacent cells 90 in a close-fit relationship therewith. To this end, the outer surface of each support member 242 includes concave contours 248 that conform to the shape of the cells 90 that surround it. In the illustrated embodiment, each support member 242 has three concave contours.

The hexagonal super cell 200 provides improved volumetric efficiency relative to that of the rectangular super cell 10 of FIG. 2. However, the volumetric efficiency of the battery pack 1 including an array of hexagonal super cells 200 is lower than that of a battery pack 1 including an array of rectangular super cells 10.

Referring to FIG. 7, another alternative embodiment super cell 300 includes cells 90a, 90b disposed in a single piece jacket 312 and supported by interstitial support members 341, 342. The jacket 312 has a rectangular shape, including four sides that extend between opposed ends 316, 318. The jacket 312 is formed for example by extrusion to have first cylindrical openings 321 dimensioned to receive a first cell 90a having a first size, and second cylindrical openings 322 dimensioned to receive a second cell 90b having a second size that is different than the first size. For example, the first cell 90a may be a 26650 cylindrical cell, and the second cell 90b may be an 18650 cylindrical cell, which is smaller in diameter than the 26650 cylindrical cell.

In this embodiment, cells 90a, 90b of different sizes are used to maximize usage of the available volume of the rectangular jacket 312. In particular, there are three openings 321 along a first diagonal D1 of the jacket first end 316, each having a maximum diameter corresponding to a size of the first cell, 90a. There are also three openings 322 on each side of the first diagonal D1, each having a maximum diameter corresponding to a relatively smaller size of the second cell 90b. As in previous embodiments, the openings 321, 322 are sized and arranged to maximize cell packing within the volume of the rectangular jacket 312 and such that each cell 90a, 90b is tangential to adjacent cells.

The openings 321, 322 extend between the first end 316 and the second end 318, and have a first diameter adjacent the first end 316 and a second, smaller diameter adjacent the second end 318. The first diameter adjacent the first end 316 corresponds to the outer diameter of the cell 90a, 90b with a clearance fit, and the second diameter adjacent the second end 318 is smaller than the outer diameter of the cell 90a, 90b while being sufficiently large to permit access to the cell terminal positioned adjacent the jacket second end 318. The stepwise transition between the first and second diameters occurs adjacent the jacket second end 318, forming a shoulder (not shown) that supports the cell end (i.e., the cell second end 93) and prevents the cells 90a, 90b from exiting the jacket 312 via the jacket second end 318. The depth of the shoulder is set such that the end of the cell 90a, 90b (i.e., the first end 92) lies flush with the jacket first end 316.

In this embodiment, there are six support members 341, 342 that are disposed the interstitial spaces between nine closely packed cells 90a, 90b. The interstitial support members 341, 342 are formed separately from the jacket 312, and each is an elongated, rod-like member having a first end 343, and a second end (not shown) opposed to the first end 343. In use, the support members 341, 342 are configured to be disposed in the interstices between adjacent cells 90a, 90b in a close-fit relationship therewith. To this end, the outer surface of each support member 341, 342 includes concave contours 348 that conform to the shape of the cells 90a, 90b that surround it. In the illustrated embodiment, a first support member 341 having four concave contours 348 is disposed in the each of the two interstitial spaces along a second diagonal D2, where the second diagonal D2 is perpendicular to the first diagonal D1. A second support member 342 having three concave contours 348 is disposed in each of the four remaining interstitial spaces. One of the first support members 341 includes a central channel 346 that extends between the opposed first and second ends of the support member 341. The channel 346 has a circular sectional shape and is formed without a dividing wall.

The super cells 10, 200, 300 described above may include an electrically conductive terminal member (not shown) disposed at each end 16, 18 of the jacket 12, 212, 312 that is used to form a parallel electrical connection between the cells 90 disposed within the openings 22, 222, 321, 322. The terminal member is also used to electrically connect the super cell 10, 200, 300 to other devices. The terminal member may be in the form of a thin, electrically conductive sheet, or alternatively may be in the form of a rigid or flexible printed circuit board.

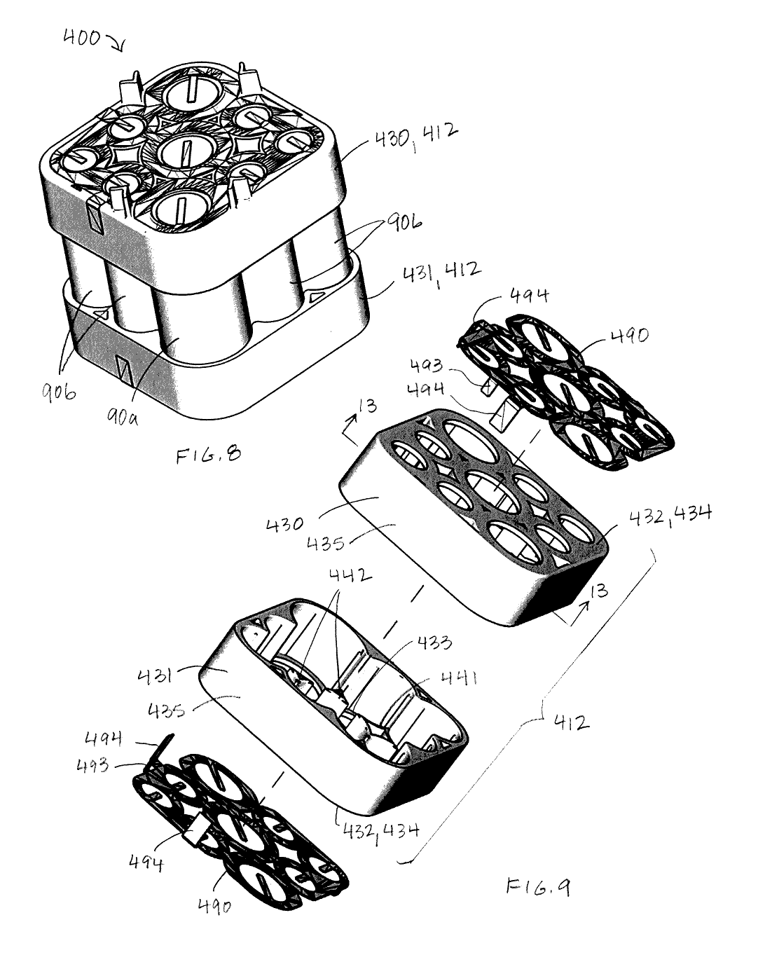

Referring to FIGS. 8 and 9, another alternative embodiment super cell 400 includes cells 90a, 90b disposed in a two-piece jacket 412 and supported by interstitial support members 441, 442. The jacket 412 includes a first tray 430 which receives and supports the first end 92 of the cells 90a, 90b and a second tray 431 which receives and supports the second end 93 of the cells 90a, 90b. The first and second trays 430, 431 are identical in size and shape, and thus only the first tray will be described in detail. In addition, elements common to both the first tray 430 and the second tray 431 will be referred to with common reference numbers.

The first tray 430 has a rectangular shape and includes a base 432 having a cell-facing surface 433 and an opposed outward-facing surface 434. The four sides of the first tray 430 form a sidewall 435 that surrounds a periphery of the base 432 and extends in a direction normal to the cell-facing surface 433.

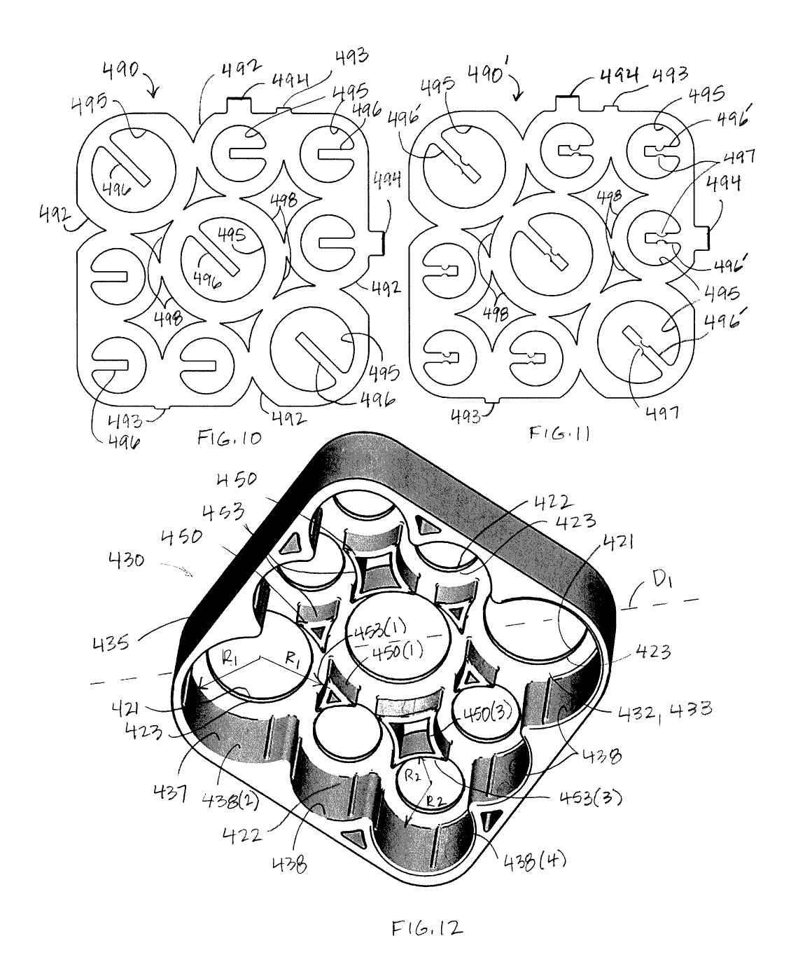

Referring to FIG. 10, the first tray 430 includes a terminal plate 490 disposed on the outward-facing surface 434. The terminal plate 490 is a thin, electrically conductive sheet that may be formed, for example, by stamping to have a complex shape. The terminal plate 490 has a generally rectangular peripheral shape with the exception of cut outs 492 at locations corresponding to recesses 439 (described below) and protruding fingers 493, 494. The terminal plate 490 has generally circular cutouts 495 formed at locations overlying the ends of each cell 90a, 90b. The terminal plate 490 also includes generally polygonal cutouts 498 formed at locations overlying the interstitial support members 441, 442.

The circular cutouts 495 permit efficient venting of the respective cells 90a, 90b. Each circular cutout 495 of the terminal plate 490 includes a tab 496 that protrudes toward a center of the circular cutout 495, and serves as a contact between the terminal plate 490 and the cell terminal 95 (or 96). The terminal plate 490 is electrically connected to each cell 90a, 90b disposed within the tray 430, 431 via a corresponding tab 496. In the illustrated embodiment, all the cells 90a, 90b are disposed within the jacket 412 in the same orientation (e.g., having the cell first end 92 received within the first tray 430), whereby the cells 90a, 90b disposed within the jacket 412 are electrically connected in parallel.

Referring to FIG. 11, in some embodiments, the terminal plate 490′ may be formed in such a way that the tab 496′ includes a necked portion 497 (e.g., a region of relatively narrow width). The necked portion 497 is configured to be destroyed at a predetermined level of current, whereby the tab 496′ serves as a fuse.

The terminal plate 490 has two types of protruding fingers 493, 494. The first type of protruding finger 493 is received within a slot 440 (FIG. 17) formed in the first tray outward-facing surface 434, and is used to locate the terminal plate relative to the first tray outward-facing surface 434, and retain the terminal plate 490 on the first tray outward-facing surface 434. The second type of protruding finger 494 is folded over one of the sides of the first tray 430, and is used to electrically connect various sensors (not shown) to the terminal plate 490, and thus permit monitoring of the cells 90a, 90b. In the illustrated embodiment, there are two of the second type of protruding finger 494, provided on adjacent orthogonal edges of the terminal plate 490.

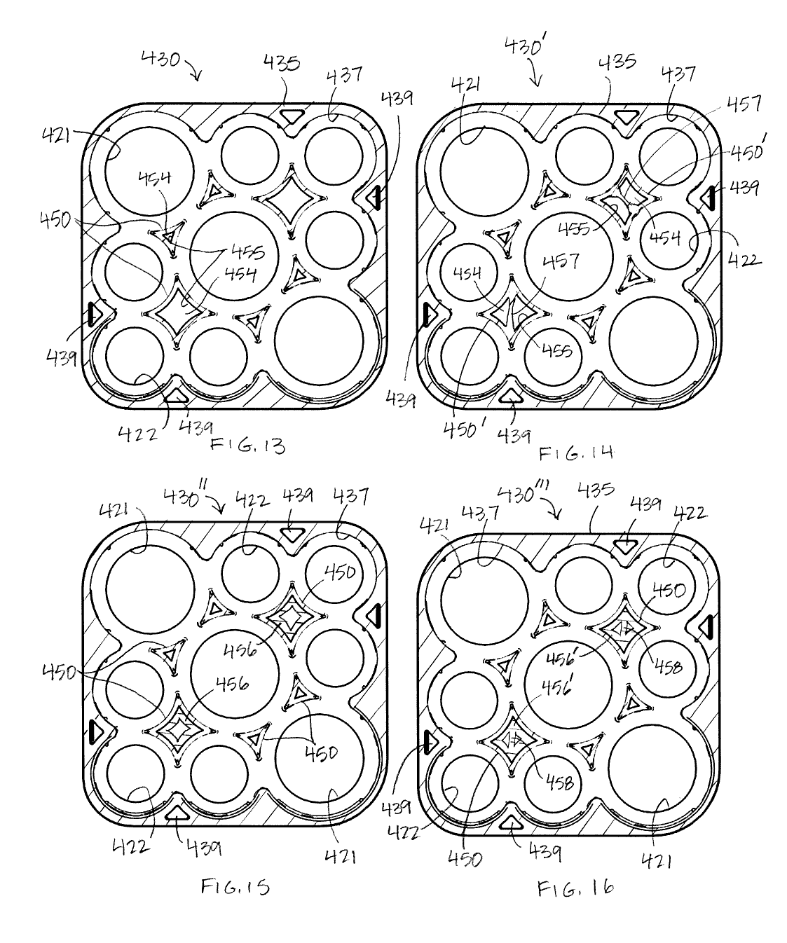

Referring to FIG. 12, the first tray 430 is formed for example by extrusion to have first partially cylindrical openings 421 dimensioned to receive the first cell 90a, and second partially cylindrical openings 422 dimensioned to receive the second cell 90b. To this end, an inner surface 437 of the first tray sidewall 435 has concave contours 438 that are configured to receive and support the cylindrical cells 90a, 90b. In particular, each concave contour 438 defines a portion of a cylindrical surface. In addition, the tray base 432 includes protrusions 450 that extend in a direction normal to the cell-facing surface 433 and are surrounded by the sidewall 435. In particular, the protrusions 450 are formed integrally with the base 432 and protrude from the cell-facing surface 433 at a location spaced apart from the sidewall 435. The outer surfaces (e.g., sidewall-facing surfaces) of the protrusions 450 have concave contours 453 that each define a portion of a cylindrical surface. The concave contours 453 of the protrusions are configured to cooperate with the concave contours 438 of the sidewalls 435 to form the openings 421, 422 that receive and support the cylindrical cells 90a, 90b.

In the illustrated embodiment, the first tray 430 is configured to support cells 90 of two different diameters, for example the cells 90a, 90b. To this end, a first concave contour 453(1) of an outer surface of a one of the protrusions 450(1) faces a corresponding second concave contour 438(2) (or 450(2)) of the sidewall 435. It is understood that in some embodiments, the first concave contour 453(1) could alternatively face a concave contour 453(2) of another one of the protrusions. In any case, the first concave contour 453(1) and the second concave contour 438(2) have a first radius R1. In addition, a third concave contour 453(3) of an outer surface of one of the protrusions 450 faces a fourth concave contour 438(4). It is understood that in some embodiments, the third concave contour 453(3) could alternatively face a concave contour 453(4) of another one of the protrusions 450(2). In any case, the third concave contour 453(3) and the fourth concave contour 438(4) have a second radius R2 that is different than the first radius R1. In this configuration, the distance between the first concave contour and the second concave contour is twice the first radius, whereby the first concave contour 453(1) and the second concave contour 438(2) are configured to cooperatively support an electrochemical cell having the first radius R1 therebetween. For example, the first radius R1 may correspond to the radius of a 26650 cylindrical cell 90a. In addition, the distance between the third concave contour and the fourth concave contour is twice the second radius, whereby the third concave contour 453(3) and the fourth concave contour 438(4) are configured to cooperatively support another electrochemical cell having the second radius therebetween. For example, the second radius R2 may correspond to the radius of a 18650 cylindrical cell 90b. As a result, at least some of the protrusions 450 have an outer surface that is defined by four concave contours 453, and others of the protrusions 450 have an outer surface that is defined by three concave contours 453.

The openings 421, 422 extend between the cell-facing surface 433 and the outward facing surface 434, and have a first diameter adjacent the cell facing surface 433 and a second, smaller diameter adjacent the outward-facing surface 434. The first diameter adjacent the cell-facing surface 433 corresponds to the outer diameter of the cell 90a, 90b with a clearance fit, and the second diameter adjacent the outward-facing surface 434 is smaller than the outer diameter of the cell 90a, 90b while being sufficiently large to permit access to the cell terminal positioned adjacent the outward-facing surface 434. The stepwise transition between the first and second diameters occurs adjacent the outward-facing surface 434, forming a shoulder 423 that supports the cell end (i.e., the cell second end 93) and prevents the cells 90a, 90b from exiting the first tray 430 via the outward-facing surface 434.

The openings 421, 422 in the first tray are arranged in the same way as the openings 321, 322 in the jacket 312 described above with respect to FIG. 7. In particular, there are three openings 421 along a first diagonal D1 of the first tray, each having a maximum diameter corresponding to a size of the first cell, 90a. There are also three openings 422 on each side of the first diagonal D1, each having a maximum diameter corresponding to a relatively smaller size of the second cell 90b.

Referring to FIG. 13, the protrusions 450 may include a through hole 454 that opens at the base outward-facing surface 434. The through hole 453 provides a lumen that can be used for multiple purposes. For example, the through hole 453 can be used as passage for cooling air, or used to receive communication buses, sensor leads or other devices, further improving the volumetric efficiency of the super cell 400. In the illustrated embodiment, the inner surface 455 of the protrusion 450, which defines the through hole 454, has the same cross-sectional shape as the outer surface of the protrusion 450a. However, the through hole 454 is not limited to this cross-sectional shape.

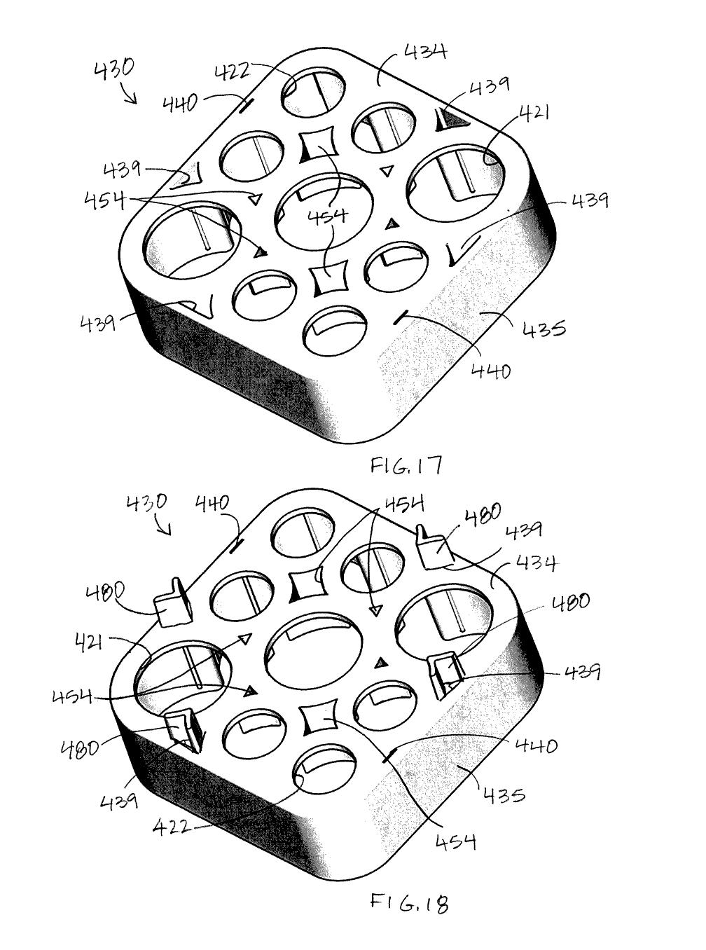

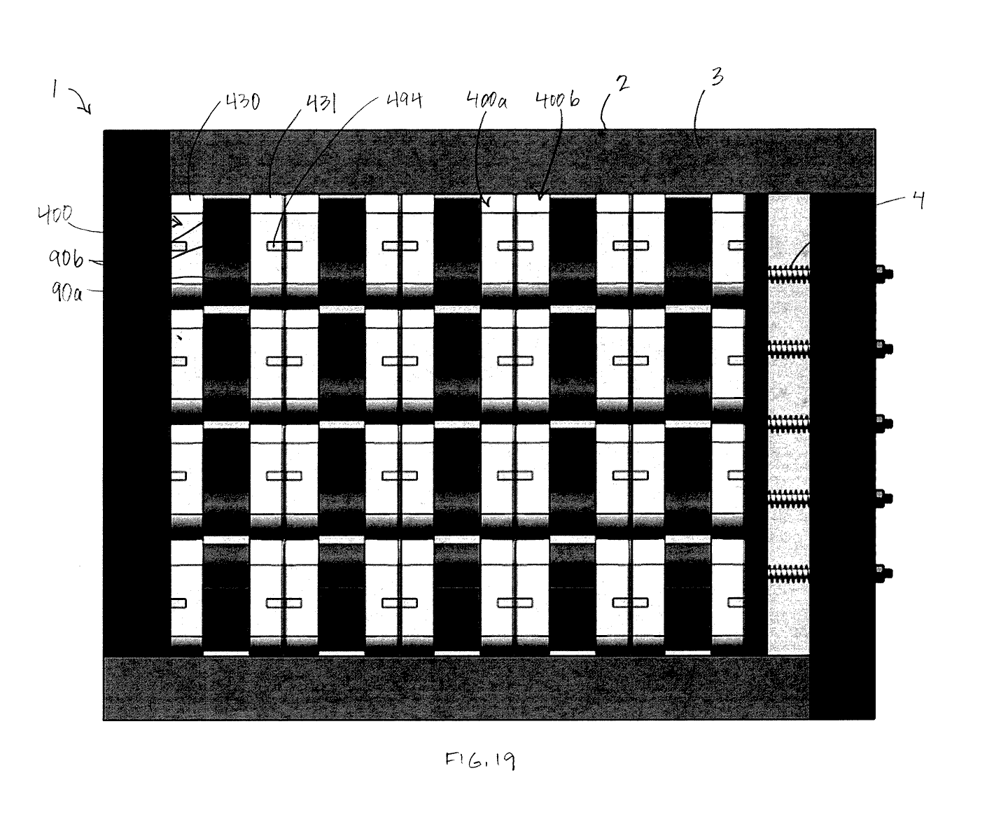

Referring to FIG. 14, in some embodiments, the protrusion through holes 454 may include a dividing wall 457 that extends between two portions of the inner surface 455 and separates the through hole 454 into multiple through holes.

Referring to FIG. 15, in some embodiments, a sleeve 456 is disposed in the protrusion through hole 454 that conforms to a shape of the protrusion inner surface 455. The sleeve 456 may be formed of a material that is different from the material that forms the protrusion 450. For example, the first tray 430 including the protrusion 450 may be formed of a relatively less expensive material that has relatively low thermal conductivity (i.e., a polymer such as polyethylene), and the sleeve 456 may be formed of a relatively more expensive material that has a relatively high thermal conductivity (i.e., aluminium). This configuration advantageously facilitates cooling of the super cell 400.

Referring to FIG. 16, in other embodiments, the protrusions 450 do not include a dividing wall that segregates the through hole 454, and the sleeve 456 is formed having a dividing wall 458 that extends between portions of an inner surface of the sleeve 456 and separates the sleeve 456 into multiple lumens.

Referring to FIGS. 17 and 18, the outward-facing surface 434 of the first tray 430 includes recesses 439 that are configured to receive an end of a connecting rib 480 that is used to join the first tray 430 of one supercell 400a to the second tray 431 of an adjacent supercell 400b. In the illustrated embodiment, the first tray 430 includes four recesses 439. Each recess 439 is disposed along the periphery of the outward-facing surface 434 at a location between adjacent concave contours 438. The recesses 439 each have a generally triangular shape to correspond to the shape of the outward-facing surface 434 between adjacent contours 438.

The super cell 400 includes four connecting ribs 480. Each connecting rib 480 is an elongated, rod-like member that is formed separately from the respective trays 430, 431. By forming the connecting ribs 480 separately from the first tray 430, it is possible to form the first tray 430 and the second tray 431 identically, thereby reducing manufacturing costs and complexity. In addition, it is possible to form the connecting ribs 480 from a different material, for example a higher strength material, than that used to form the first tray 430.

In some embodiments, the connecting ribs 480 have a V-shaped (illustrated) or triangle-shaped (not shown) cross-sectional shape to correspond to the shape of the recess 439. The connecting rib 480 cross-sectional shape is dimensioned to closely fit or be press fit within the recess 439. In addition, the length of the connecting rib 480 is greater than the depth of the recess 439 and less than twice the depth of the recess 439. This arrangement permits one end of the connecting rib 480 to be received within the recess 439 of the first tray of one supercell 400a, and the opposed end of the connecting rib 480 to be received within the recess 439 of the second tray 431 of an adjacent supercell 400b while permitting the respective terminal plates 490 disposed on the outward facing surfaces 434 to touch and form a direct electrical connection. This is advantageous since it permits close packing of the super cells 400 within a battery pack housing 2, and since there is no need for buss bars or other devices to form the electrical connection between the super cells.

Referring to FIG. 19, an array of super cells 400 are disposed in the battery pack housing 2. The array of super cells 400 includes four rows of super cells 400, where each row includes five super cells 400. Within a row, the super cells 400 are connected end-to-end via intermediate connecting ribs 480 (not seen in FIG. 19), while the respective terminal plates 490 are in contact and form a serial connection along each row. A bus bar or other conductive element (not shown) is used to electrically connect super cells at the ends of adjacent rows, so that a serial connection is formed along all super cells within the battery pack housing 2. At the end of each row, an elastic element such as a compression spring 4 may be provided between the battery pack housing 2 and the outermost super cell 400. The spring 4 urges the super cells 400 within a given row together, facilitating and/or ensuring the direct electrical connection between the respective terminal plates 490 disposed on the outward facing surfaces 434 of adjacent super cells 400.

Although the battery packs illustrated in FIGS. 1 and 19 include an array of supercells 10, 400 including four rows of five super cells, the battery packs 1 are not limited to this size array. For example, the battery pack 1 may include a greater or fewer number of rows, and a greater or fewer number of super cells within the rows. In addition, the battery pack 1 is not limited to a two-dimensional array of super cells, and instead may be a three-dimensional array.

Although the first and second trays 430, 431 have been describe herein as including protrusions 450 that are formed integrally with the base, the first and second trays 430, 431 are not limited to this configuration. For example, the protrusions 450 may be formed separately from the base 432, and disposed within a recess formed in the cell-facing surface 433 at a location spaced apart from the sidewall 435. In some embodiments, the separately-formed protrusions 450 may be formed of a material that is different than the material used to form the first and second trays 430, 431.

In the embodiment illustrated in FIGS. 12-16, all of the protrusions 450 include a through hole 454. However, the protrusions 450 are not limited to this configuration. For example, in other embodiments, some of the protrusions 450 include the through hole 454 and the others of the protrusions are through hole free.

Although the cells 90 are described herein as being lithium-manganese (li-mn) cells, they are not limited to this type of cell chemistry. For example, is some embodiments, the cells 90 may be other types of lithium-ion, nickel-cadmium, nickel-metal-hydride, lead-acid or other type of cell chemistry.

In the illustrated embodiment, the super cell 400 may include a terminal plate 490 disposed on the outward-facing surface of the first and second trays 430, 431. However, the supercell 400 is not limited to this configuration. For example, the terminal plate 490 may be replaced by a rigid or flexible printed circuit board.

Selective illustrative embodiments of the battery cell and electrode assembly are described above in some detail. It should be understood that only structures considered necessary for clarifying these devices have been described herein. Other conventional structures, and those of ancillary and auxiliary components of the battery system, are assumed to be known and understood by those skilled in the art. Moreover, while working examples of the battery cell and electrode assembly been described above, the battery cell and/or electrode assembly is not limited to the working examples described above, but various design alterations may be carried out without departing from the devices as set forth in the claims.

What is claimed is:

1. A super cell housing configured to receive cylindrical electrochemical cells, the super cell
housing comprising
a first tray including
a base having a cell-facing surface and an opposed outward-facing surface,
a sidewall surrounding a periphery of the base, a sidewall inner surface having concave contours that each define a portion of a cylindrical surface, and
protrusions that extend in a direction normal to the cell-facing surface and are surrounded by the sidewall, outer surfaces of the protrusions having concave contours that each define a portion of a cylindrical surface, at least one of the protrusions including a through hole that opens at the outward-facing surface.

2. The super cell housing of claim 1, wherein the at least one of the protrusions has an inner surface that defines the through hole, and the inner surface has the same cross-sectional shape as the outer surface of the at least one of the protrusions.

3. The super cell housing of claim 2, wherein the at least one of the protrusions includes a dividing wall that extends between two portions of the inner surface and separates the through hole into multiple through holes.

4. The super cell housing of claim 2, wherein the at least one of the protrusions includes a sleeve disposed in the through hole that conforms to a shape of the protrusion inner surface, the sleeve being formed of a material that is different from the material that forms the protrusion.

5. The super cell housing of claim 4, wherein the sleeve includes a dividing wall that extends between two portions of an inner surface of the sleeve and separates the sleeve into multiple through holes.

6. The super cell housing of claim 1, wherein a first concave contour of an outer surface of one of the protrusions faces, and has a same radius as, a second concave contour of the sidewall or of another one of the protrusions, and
the distance between the first concave contour and the second concave contour is twice the radius, whereby the first concave contour and the second concave contour are configured to cooperatively support an electrochemical cell having the radius therebetween.

7. The super cell housing of claim 1, wherein the super cell comprises a second tray that is spaced apart from the first tray, the second tray including protrusions that protrude toward the protrusions of the first tray.

8. The super cell housing of claim 1, wherein the outward-facing surface includes recesses that are configured to receive an end of a connecting rib.

9. The super cell housing of claim 1, comprising a connecting rib that protrudes outward from the outward-facing surface.

10. The super cell housing of claim 1, wherein a terminal plate is provided on the outward-facing surface of the first tray, the terminal plate configured to form an electrical connection with each cell disposed in the tray.

11. A battery pack including a first super cell and a second super cell that is connected to the first supercell via a connector, wherein each of the first super cell and the second super cell include a super cell housing, and the super cell housing includes a first tray having
a base having a cell-facing surface and an opposed outward-facing surface,
a sidewall surrounding a periphery of the base, a sidewall inner surface having concave contours that each define a portion of a cylindrical surface, and
protrusions that extend in a direction normal to the cell-facing surface and are surrounded by the sidewall, outer surfaces of the protrusions having concave contours that each define a portion of a cylindrical surface, at least one of the protrusions including a through hole that opens at the outward-facing surface.

12. The battery pack of claim 11, wherein the connector is a rod that is formed separately from each of the first supercell and the second supercell, the rod having a first end and a second end that is opposed to the first end, and wherein the first end is disposed within a recess formed in the first supercell, and the second end is disposed within a recess formed in the second supercell.

13. The battery pack of claim 11, wherein the connector has a first end that is received within a first opening formed in the outward-facing surface of the first tray, and a second end opposed to the first end, the second end received within a second opening formed in an outward-facing surface of the second tray.

14. The battery pack of claim 11, wherein the connector is a rod having a triangular cross sectional shape.

15. The battery pack of claim 11, wherein the base is formed of a first material and the connector is formed of a second material, and the first material is different from the second material.

16. The battery pack of claim 15, wherein the at least one of the protrusions has an inner surface that defines the through hole, and the inner surface has the same cross-sectional shape as the outer surface of the at least one of the protrusions.

17. The battery pack of claim 15, wherein the at least one of the protrusions includes a dividing wall that extends between two portions of the inner surface and separates the through hole into multiple through holes.

18. The battery pack of claim 15, wherein the at least one of the protrusions includes a sleeve disposed in the through hole that conforms to a shape of the protrusion inner surface, the sleeve being formed of a material that is different from the material that forms the protrusion.

19. The battery pack of claim 18, wherein the sleeve includes a dividing wall that extends between two portions of an inner surface of the sleeve and separates the sleeve into multiple through holes.

20. The battery pack of claim 19, wherein a terminal plate is provided on the outward-facing surface of the first tray, the terminal plate forming an electrical connection with each cell disposed in the tray.
